(19) United States
(12) Patent Application Publication
(10) Pub. No.: US 2026/0215369 A1
(43) Pub. Date: Jul. 30, 2026

(54) SCENARIO DEPENDENT CONTROLS IN AN AUTOMATED UNLOADING PROCESS

(71) Applicant: Deere & Company, Moline, IL (US)

(72) Inventors: PATRICK SAUER, Mannheim (DE); CHRISTIAN WAIBEL, Mannheim (DE)

(21) Appl. No.: 19/364,090

(22) Filed: Oct. 21, 2025

(30) Foreign Application Priority Data
Jan. 28, 2025 (EP) 25154304.7

(51) Int. Cl. A01D 90/10; B65G 67/22; G05D 3/12

(52) U.S. Cl. CPC A01D 90/10; B65G 67/22; G05D 3/12

(57) ABSTRACT

An arrangement is provided for automatically supervising a transfer process in which harvested material is transferred from a harvesting machine into a cargo container of a transport vehicle. The arrangement is equipped with an electronic control unit configured to generate, on the basis of signals supplied thereto, a positioning signal for one or more actuators to influence the location of the impact point of the harvested material in the cargo container in terms of transferring the harvested material to a target position in the cargo container with a predeterminable response sensitivity to a deviation between the target position and the actual position of the impact point. The control unit increases the response sensitivity when transfer losses are detected.

### CROSS-REFERENCE TO RELATED APPLICATIONS

This application claims the benefit of European Patent Application No. 25154304.7, filed on January 28, 2025, the disclosure of which is hereby incorporated by reference.

### TECHNICAL FIELD

The present disclosure relates to an arrangement for automatically supervising a transfer process, in which harvested material is transferred from a harvesting machine into a cargo container of a transport vehicle.

### BACKGROUND

When harvesting agricultural products on a field using a harvesting machine, it is routine practice that a transport vehicle travels along adjacent to the harvesting machine and is loaded with harvested plant material. A cargo container of the transport vehicle, which is for example a tractor having trailer or a truck, is loaded with the harvested product during the journey by a discharge unit of the harvesting machine, for example in a forage harvester by a discharge spout and in a combine harvester by a discharge pipe. The discharge unit is generally fastened rotatably around a vertical axis on the harvesting machine and is pivotable between a shutdown position, in which it is oriented approximately parallel to the longitudinal axis of the harvesting machine, and a working position, in which it extends transversely to the travel direction of the harvesting machine.

With discharge units adjustable in operation, as are typically used on forage harvesters, there is the possibility of varying the angle of the discharge unit around the vertical axis. In addition, the height of the delivery-side end of the discharge unit is variable, as is the position of a discharge flap, which defines the angle at which the harvested product is delivered. The position of the discharge unit is manually controlled by the driver of the harvesting machine in the simplest case, for which input units in the cab are available to him, which activate actuators used for adjusting the discharge unit. The driver of the harvesting machine has to ensure in this case that the entire cargo container of the transport vehicle is sufficiently filled, which is carried out by successively orienting the discharge unit toward different points on the cargo container. Alternatively or additionally, the driver of the transport vehicle changes its position in relation to the harvesting machine in the forward direction and possibly in the lateral direction in order to fill different areas of the cargo container in succession. This procedure is also typical in combine harvesters, which generally have no discharge unit or a discharge unit adjustable in operation only around the vertical axis (see EP 2893797 A2).

A large number of proposals have been made in the prior art to automate the transfer process, whether by automatically supervising the orientation of the transfer unit in relation to the harvesting machine and thus the throwing direction of the delivered harvested material and/or by supervising the position of the cargo container of the transport vehicle in relation to the harvesting machine. It is therefore detected by a sensor and/or calculated by a model at which point the harvested material lands on the cargo container, and the orientation of the transfer unit and/or relative position of the cargo container is supervised (regulated or controlled) accordingly, wherein the adjustment of the transfer unit generally enables a faster response than a readjustment of the relative position (see EP 1393613 A2, EP 2510775 A1 and EP 2827213 A2). A specific loading strategy can be worked out for this purpose in order to fill different points of the cargo container gradually (DE 102011005400 A1), and it has been proposed that external conditions be taken into consideration in the supervision of the transfer process.

These conditions can relate, for example, to the current or future movement status of the harvesting machine and the transport vehicle. EP 3 150 052 A1 proposes for this purpose that a possible rotation of the harvesting machine around the vertical axis, i.e., when traveling around curves, also be detected in the activation of the transfer unit and be taken into consideration in the activation of the transfer unit in order to ensure that the harvested material lands at the intended point on the cargo container even when traveling around curves, while EP 3062597 A1, EP 3970471 A1, and EP 4046474 A1 propose using a known path of the harvesting machine to be traveled in future for this purpose. WO 2012/110543 A1 describes control of the relative position of a transport vehicle in relation to a harvesting machine on the basis of the detected positions, in which, inter alia, the relative velocity of the two in relation to one another is taken into consideration to determine the supervision signal. The external conditions are incorporated in the supervision process in the documents cited in this paragraph in the form of a correction of the relative position to be expected for the future.

Furthermore, the conditions can relate to properties of the harvested material. Thus, EP 1 977 640 A1 proposes selecting the dimensions of an edge zone of the cargo container to which harvested material is not applied in dependence on the type, dryness, and chop length of the harvested material, in order to avoid losses. Moreover, the size of the edge zone can depend on the velocity of both vehicles and the relative velocity. EP 3 949 714 A1 describes model-based filling of the cargo container based, inter alia, on properties of the harvested material (type, density, and moisture), with a correction option by the operator and a self-learning function for the model based thereon. The external conditions (dependent, inter alia, on the properties of the harvested material) are used here to define the boundaries of the loadable area of the cargo container or to ascertain the expected point at which the harvested material reaches the cargo container.

DE 102023100539 A1, which is regarded as forming the generic type, describes consideration of the type of harvested material for checking, among other things, the manipulated variable at the actuator by adjusting a parameter (in particular a proportional factor) of an inner control loop for activating the actuator. In addition, this parameter can be set more aggressively in the event of larger relative movements between the harvesting machine and the cargo container, which occur in particular when traveling around an inner curve, than when traveling in a straight line. This parameter defines the extent of the response of the actuator for a given deviation of the current impact point from a desired impact point. On the one hand, the parameter influences how aggressively a response to a possible deviation occurs and thus the accuracy of the transfer process; on the other hand, the result may be an overly hectic regulating behavior, which is also perceived to be detrimental by an operator of the harvesting machine in their cab.

During transfer, situations may occur in which no or only part of the harvested material reaches the cargo container. In such cases, the procedure known in the prior art provides for a transition from a (slower) regulation of the relative position to a (faster) regulation of the position of the transfer unit (EP 2510775 A1 and EP 2827213 A2), which has the disadvantage that the constant parameter of the control loop must be adapted to both situations (difficult and easy transfer situation).

### SUMMARY

An object underlying the present disclosure is considered that of providing an improved arrangement for automatically supervising a transfer process from a harvesting machine to a transport vehicle.

This object is achieved according to the present disclosure, such as by the teachings of one or more embodiments disclosed herein, wherein features refining the achievement of the object are set forth in the further claims.

An arrangement for automatically supervising a transfer process, in which harvested material is transferred from a harvesting machine into a cargo container of a transport vehicle, is equipped with an electronic control unit which is configured to generate, on the basis of signals supplied thereto, a positioning signal for one or more actuators to influence the location of the impact point of the harvested material in the cargo container in terms of transferring the harvested material to a target position in the cargo container with a predeterminable response sensitivity to a deviation between the target position and the actual position of the impact point. The control unit is configured to increase the response sensitivity when transfer losses are detected.

In other words, a lower response sensitivity is chosen for unproblematic transfer processes than when transfer losses occur. These transfer losses are thus avoided as far as possible, since a fast response takes place. In the case of unproblematic transfer processes, however, the response sensitivity is lower, which improves operator comfort.

Other features and aspects will become apparent by consideration of the detailed description and accompanying drawings.

### BRIEF DESCRIPTION OF THE DRAWINGS

FIG. 1 is a side view of a self-propelled harvesting machine and a transport vehicle

FIG. 2 is a schematic top view of the harvesting machine and the transport vehicle, which jointly carry out a harvesting and transfer process on a field, wherein the harvested material is transferred to the cargo container of the transport vehicle.

FIG. 3 is a rear view of the harvesting machine and the transport vehicle from FIG. 2.

FIG. 4 is a schematic illustration of the control unit for supervising the transfer of the harvested material.

FIG. 5 is a diagram of the structure and the functionality of the electronic control unit for supervising the transfer process.

### DETAILED DESCRIPTION

For the purposes of promoting an understanding of the principles of the present disclosure, reference will now be made to the implementations illustrated in the drawings, and specific language will be used to describe the same. It will nevertheless be understood that no limitation of the scope of the disclosure is intended. Any alterations and further modifications to the described devices, systems, or methods and any further application of the principles of the present disclosure are fully contemplated as would normally occur to one skilled in the art to which the disclosure relates. In particular, it is fully contemplated that the features, components, and/or steps described with respect to one implementation may be combined with the features, components, and/or steps described with respect to other implementations of the present disclosure.

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

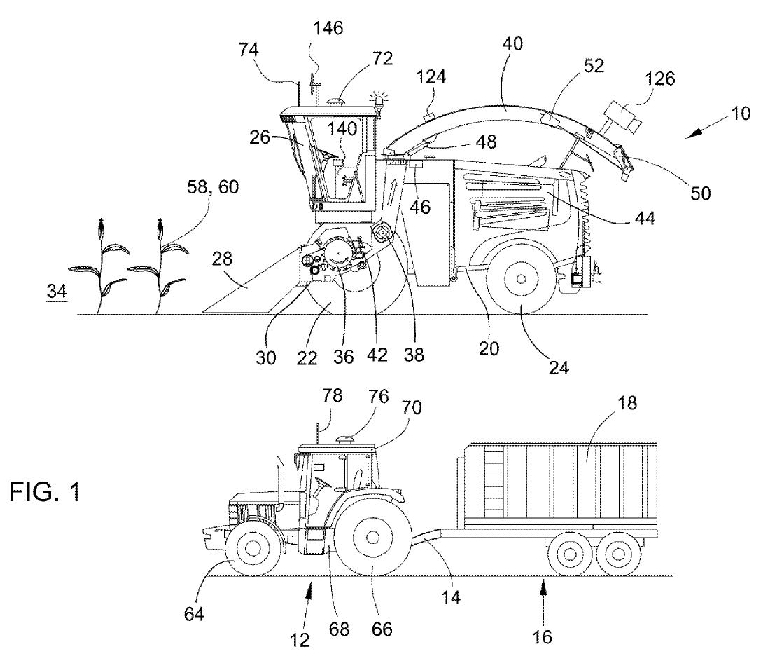

A combination of two agricultural machines shown in FIG. 1 comprises a harvesting machine 10 in the manner of a self-propelled forage harvester and a transport vehicle 12 in the manner of a self-propelled tractor, which pulls a trailer 16, which comprises a cargo container 18, by a drawbar 14.

The harvesting machine 10 is built on a frame 20, which is supported by front driven wheels 22 and steerable rear wheels 24. The harvesting machine 10 is operated from a driver cab 26, from which a harvesting header 28 in the form of a corn cutting header is visible, which is fastened at an intake channel 30 on the front side of the harvesting machine 10. Harvested material picked up from a field 34 by the harvesting header 28 is supplied, via an intake conveyor having feed rollers and arranged in the intake channel 30, to a cutterhead 36, which chops it into small pieces and delivers it to a fan 38. A secondary crushing device 42 having two grain processor rollers extends between the cutterhead 36 and the fan 38. The mentioned drivable assemblies of the harvesting machine 10 and the harvesting header 28 are driven by an internal combustion engine 44.

The material discharged from the fan 38 leaves the harvesting machine 10 to the cargo container 18 driving alongside via a discharge unit, which is composed of a stationary discharge shaft adjoining the fan 38 directly on top and a discharge spout 40, which is rotatable by a first, power-operated actuator 46 around an approximately vertical axis and is adjustable in terms of its inclination by a second, power-operated actuator 48, the discharge direction of which is changeable by a discharge flap 50, the inclination of which is adjustable by a third, power-operated actuator 52. The discharge spout 40 and the discharge flap 50 are shown in their transport position in FIG. 1, into which they are brought, for example, when the harvesting machine 10 drives on a road. During the harvesting process, the discharge spout 40 is raised by the actuator 48 and, by the actuator 46, either rotated to a side of the harvesting machine 10 if sufficient space is available after harvesting to the side of the harvesting machine 10 for the transport vehicle 12 on a harvested area 56 of the field, or the discharge spout 40 remains in the position oriented to the rear according to FIG. 1 if initially a lane is cut into the field during harvesting, but is raised by the actuator 48.

The transport vehicle 12 and the trailer 16 are of conventional design. The transport vehicle 12 comprises front steerable wheels 64 and rear driven wheels 66, which are supported on a frame 68, which carries a driver cab 70.

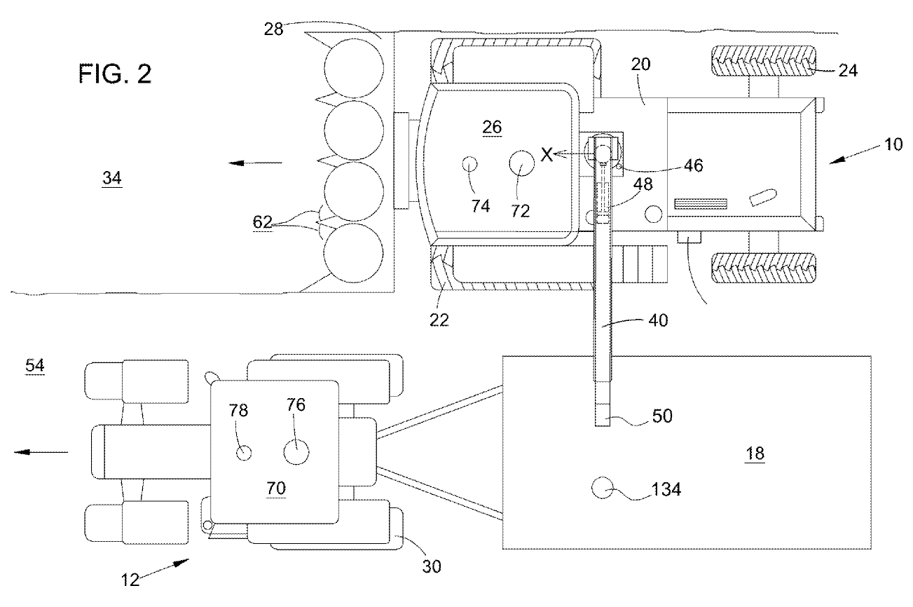

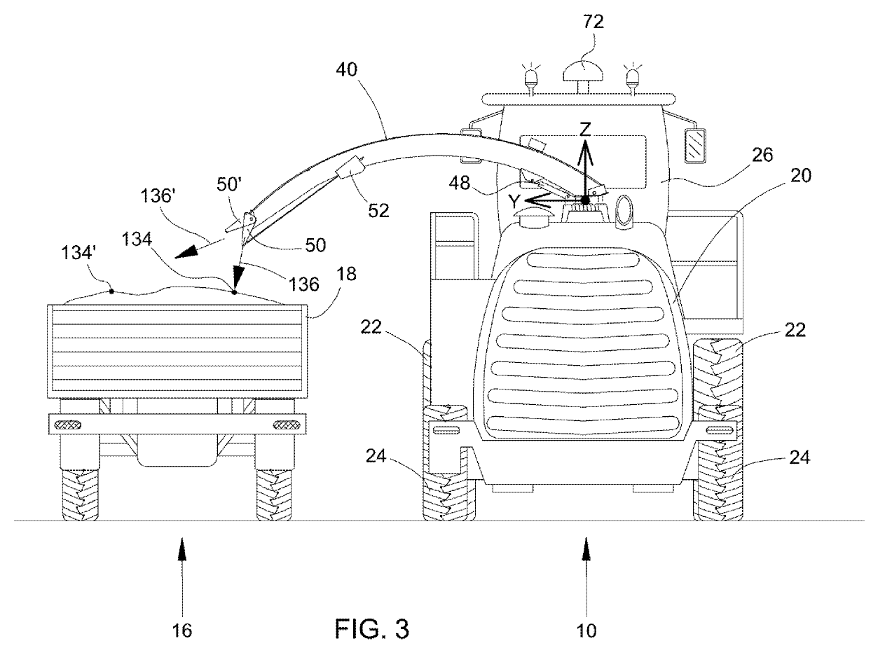

The harvesting machine 10 and the transport vehicle 12 are shown in a top view in FIG. 2. It is apparent that the harvesting machine 10 travels along a harvested material edge, which represents a boundary between the harvested area 54 of the field 34 and the still standing stock 60 of the field 34 occupied with corn plants 58, and harvests the plants 58. The transport vehicle 12 travels on the harvested area 54 of the field 34 parallel to the harvesting machine 10 along a path on which the plants cut by the harvesting machine 10 reach the first cargo container 18 through the discharge unit. The transport vehicle 12 typically travels parallel and adjacent to the harvesting machine 10, as shown in FIG. 2. During harvesting, the transport vehicle 12 travels behind the harvesting machine 10, since a harvested part 54 of the field 34 is not yet present, on which the transport vehicle 12 could travel without damaging the plants there. A rear view of the situation shown in FIG. 2 is shown in FIG. 3.

The harvesting machine 10 is steered by a driver seated in the driver cab 18 or by an automatically working steering device on the basis of sensing bands 62 for detecting the harvested material rows or a camera for detecting harvested material rows in front of the harvesting machine 10 or on the basis of the detected position and a map of the field. The transport vehicle 12 is also equipped with a steering unit, described in more detail hereinafter, to facilitate or automate the parallel driving in relation to the harvesting machine 10. The harvesting machine 10 could also be any other self-propelled harvesting machine, such as a combine harvester or beet harvester, in which the transfer unit is generally not adjustable in operation.

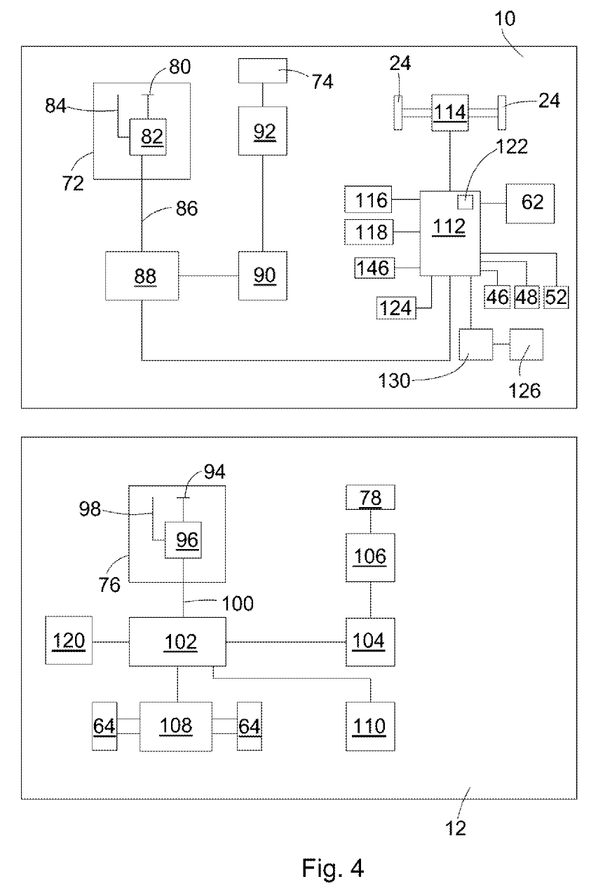

The harvesting machine 10 is equipped with a first position determination unit 72 for receiving signals of a satellite-based navigation system (GNSS), which is located on the roof of the cab 26. A first radio antenna 74 is also positioned there. The transport vehicle 12 is equipped with a second position determination unit 76, which is located on the roof of the cab 70. A second radio antenna 78 is also positioned there. In addition, the harvesting machine 10 is equipped with a sensor arrangement 126, which is attached at the outer end of the discharge spout 40 and is used to detect the contours of the cargo container 18 and/or its fill level with harvested material. The sensor arrangement 126 can be an ultrasonic or laser distance meter two-dimensionally scanning its field of view directed toward the cargo container 18, or it is a three-dimensionally operating (PMD) camera, or two cameras, which generate a stereo image, or a two-dimensionally operating camera which is combined with a distance meter scanning the field of view, or a single monocular camera. The output signal of the sensor arrangement 126 is processed by a processing circuit 130 (cf. FIG. 4).

Reference will now be made to FIG. 4, in which the individual components of the arrangement for supervising the transfer of the harvested material from the harvesting machine 10 to the cargo container 18, including the sensor arrangement 126 and the position determination units 72, 76, and the steering unit of the transport vehicle 12 and the harvesting machine 10, are schematically shown. The first position determination unit 72, which comprises an antenna 80 and an evaluation circuit 82 connected to the antenna 80, is located on board the harvesting machine 10. The antenna 80 receives signals from satellites of a position determination system, such as GPS, Galileo, or Glonass, which are supplied to the evaluation circuit 82. The evaluation circuit 82 determines the current position of the antenna 80 on the basis of the signals of the satellites. The evaluation circuit 82 is furthermore connected to a correction data receiving antenna 84, which receives radio waves emitted by reference stations at known locations. Correction data for improving the accuracy of the position determination unit 72 are generated on the basis of the radio waves by the evaluation circuit 82.

The evaluation circuit 82 passes on its position data to a computer unit 88 through a bus line 86. The computer unit 88 is connected via an interface 90 to a receiving and transmitting unit 92, which is in turn connected to the radio antenna 74. The receiving and transmitting unit 92 receives and generates radio waves, which are received or emitted by the antenna 74.

Similarly, a second position determination unit 76, which comprises an antenna 94 and an evaluation circuit 96 connected to the antenna 94, is located on board the transport vehicle 12. The antenna 94 receives signals from satellites of the same position determination system as the antenna 80, which are supplied to the evaluation circuit 96. The evaluation circuit 96 determines the current position of the antenna 94 on the basis of the signals of the satellites. The evaluation circuit 96 is furthermore connected to a correction data receiving antenna 98, which receives radio waves emitted by reference stations at known locations. Correction data for improving the accuracy of the position determination unit 76 are generated on the basis of the radio waves by the evaluation circuit 96.

The evaluation circuit 96 passes on its position data to a computer unit 102 through a bus line 100. The computer unit 102 is connected via an interface 104 to a receiving and transmitting unit 106, which is in turn connected to the radio antenna 78. The receiving and transmitting unit 106 receives and generates radio waves, which are received or emitted by the antenna 78. Data can be transmitted from the computer unit 88 to the computer unit 102 and vice versa by the receiving and transmitting units 90, 106 and the radio antennas 74, 78. The connection between the radio antennas 74, 78 can be direct, for example in an authorized radio range such as CB radio or the like, or can be provided via one or more relay stations, for example if the receiving and transmitting units 90, 106 and the radio antennas 74, 78 operate according to the GSM standard or another suitable standard for mobile telephones.

The computer unit 102 is connected to a steering unit 108, which controls the steering angle of the front, steerable wheels 64. In addition, the computer unit 102 transmits velocity signals to a velocity specification unit 110, which controls the velocity of the transport vehicle 12 by varying the engine speed of the transport vehicle 12 and/or the transmission ratio. In addition, the computer unit 102 is connected to a permanent memory 120.

The computer unit 88 is connected to a control unit 112 on board the harvesting machine 10. The control unit 112 is connected to a steering unit 114, which controls the steering angle of the rear steerable wheels 24. In addition, the control unit 112 transmits velocity signals to a velocity specification unit 116, which controls the velocity of the transport vehicle 12 by varying the transmission ratio. The control unit 112 is furthermore connected to a throughput sensor 118, which detects the distance between the feed rollers in the intake channel, to a sensor for detecting the position of sensing bands 62 attached to a distributor tip of the harvesting header 28, a permanent memory 122, the processing circuit 130, and to the actuators 46, 48, and 50.

In harvesting operation, the harvesting machine 10 is steered along the harvested material edge in that the control unit 112 gives steering signals to the steering unit 114, which are based on the signals from the position determination unit 72 and a map that is stored in the memory 122 and defines a planned path for the coming harvesting process, or on signals from the sensing bands 62 or a combination of both signals. Alternatively or additionally, the harvested material edge is detected using a two-dimensional or three-dimensional camera and an image processing system or a laser or ultrasonic sensor or scanner and is used to generate the steering signal for the steering unit 114. The path of the harvesting machine 10 does not necessarily have to run straight, but can also comprise curves depending on the shape of the field. In addition, turning processes are provided at the end of the field.

The advance velocity of the harvesting machine 10 can be specified by its driver, or the control unit 112 uses the throughput signals of the throughput sensor 118 to activate the velocity specification unit 116 such that a desired throughput is achieved by the harvesting machine 10.

In addition, the transport vehicle 12 is guided parallel to the harvesting machine 10, in that the control unit 112 transmits data with respect to the position to be maintained by the transport vehicle 12 to the computer unit 102 via the computer unit 88 and the radio antennas 74, 78. The computer unit 102 then activates the steering unit 108 and the velocity specification unit 110 accordingly in that it compares the position detected using the position determination unit 76 with the position to be maintained and gives suitable steering signals to the steering unit 108 depending on the result of the comparison. This comparison and the generation of the steering signal for the steering unit 108 could also be carried out by the computer unit 88 and/or the control unit 112 on board the harvesting machine 10, wherein the position data are transmitted from the position determination unit 76 of the transport vehicle via the radio antennas 74, 78 to the harvesting machine 10, while the steering signals are transmitted in the reverse direction back to the transport vehicle 12. The transport vehicle 12 also follows the harvesting machine 10 when traveling around curves and when turning at the end of the field. The discharge unit is aligned automatically with the cargo container 18 by the control unit 112 by appropriate activation of the actuators 46, 48, 52, for which purpose the control unit 112 uses signals from the processing circuit 130 and/or from the computer unit 88.

In this case, the load status of the cargo container 18 is detected, for which purpose the signals of the processing circuit 130 are used, which can be supplemented or replaced by highly integrated signals from a throughput sensor 118 and/or signals from a content sensor 124, designed as a near infrared spectrometer, for detecting contents of the harvested material. As long as the cargo container 18 is not completely filled, it is checked whether a desired target fill level is reached at the point of the cargo container 18 to which harvested material is presently applied. If this is the case, the discharge unit is aligned with another point of the cargo container 18. A specific loading strategy is used here, which fills the cargo container 18 from front to back or vice versa, wherein in each case harvested material is applied to one point 134 until a specific fill level is reached, and then harvested material is loaded again at a point displaced by one step width to the front or rear. The harvested material can be applied here to the middle of the cargo container 18 with respect to the lateral direction, or another laterally offset point (cf. reference sign 134' in FIG. 3, for which purpose the discharge direction 136, 136' is changeable by the discharge flap 50 in that the discharge flap can be moved into the position 50'), or it can be applied to both in succession. The signals of the processing unit 130 are accordingly used in step 212 to activate the actuators 46, 48, 52. Additionally or alternatively, the position of the transport vehicle 12 is varied in relation to the harvesting machine 10 in the forward direction and/or in the lateral direction in that the control unit 112 transmits corresponding data with respect to the position to be maintained by the transport vehicle 12 to the computer unit 102 via the computer unit 88 and the radio antennas 74, 78. The path of the harvested material between the delivery end of the discharge unit and the cargo container 18 can thus be kept relatively short, which provides that, in the event of wind, few harvested material losses result and the harvested material is pre-compacted on the cargo container 18.

It is to be noted that, in a one embodiment, the driver of the harvesting machine 10 steers it and specifies its velocity, while the drivers of the transport vehicles 12 steer them and specify their velocities. Thus, in such an embodiment, the control unit 112 then only supervises the actuators 46, 48, and 52.

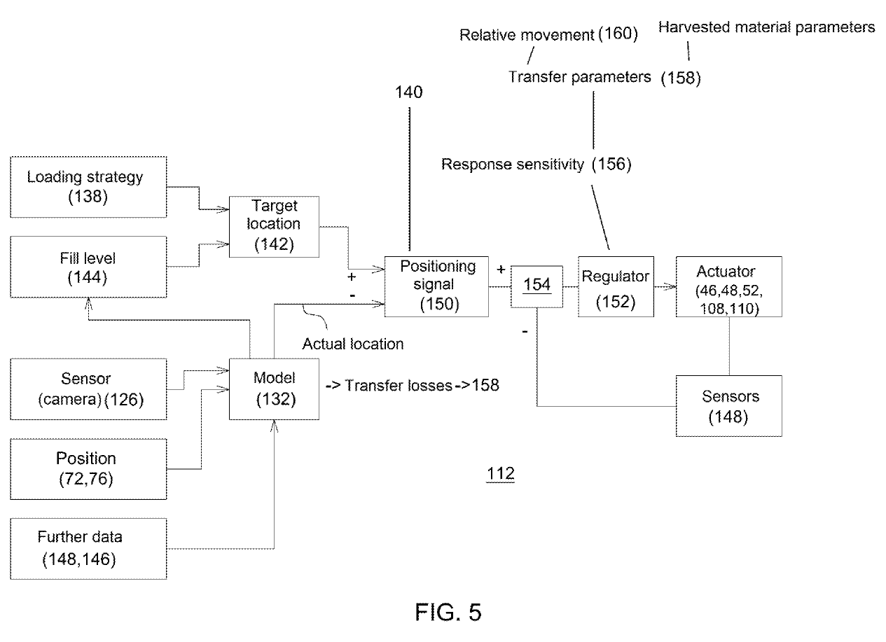

FIG. 5 shows a diagram of the structure and the functionality of the electronic control unit 112 when supervising the transfer process.

It will first be described how a desired impact location 134 is calculated. For this purpose, data for different loading strategies 138 are stored or definable in the memory 122, which can be selected or input, for example, by the operator via an operator interface 140 depending on the type and size of the cargo container 18. Automatic identification of the cargo container 18 by the sensor arrangement 126 is also conceivable. In this respect, reference is made to the disclosure of DE 102008002006 A1. The loading strategy 138 defines, as already described above, at which impact locations 134 the harvested material is to be deposited on the cargo container 18 and in which sequence. A module 142 calculates the desired impact location on the basis of the selected or input or automatically calculated loading strategy and on the basis of a fill level at the respective impinged impact location 134, which is calculated by a module 144. This can take place in the above-described manner, e.g., in that harvested material is applied to each impact location of the loading strategy 138 a single time until a desired fill level is reached. Other procedures are also conceivable, for example with continuous variation of the impact location or repeated filling up to different filling heights. The impact locations 134 do not necessarily have to be located one behind another on the cargo container, but can also be adjacent to one another.

Furthermore, it will now be described how the current impact location is calculated by a model 132. The model 132 uses the signals from the processing circuit 130, e.g., the image signals of the sensor arrangement 126, to identify the position of the border of the cargo container 18 and, on the basis thereof, the current impact point 134. Alternatively or additionally, the signals of the position determination units 72 and 76 can be used, on the basis of which the relative position between reference points of the harvesting machine 10 and the cargo container 18 can be ascertained. The flight behavior of the harvested material can be ascertained on the basis of the signals from sensors 148, which are assigned to the three actuators 46, 48, 52, and on the basis of a wind sensor 146. Data on the harvested material with respect to the type and contents, such as moisture, detected using the content sensor 124, and the chop length (ascertainable on the basis of the rotational velocity of the feed rollers in the intake channel 30 and the rotational velocity of the cutterhead 36) can also be incorporated in the model 132. Furthermore, the model 132 can transmit the fill level at the respective impinged point to the module 144. Further details with respect to the model 132 are disclosed in EP 3949714 A1 and the documents cited therein, the disclosures of which are incorporated by reference in the present documents. As discussed in EP 3949714 A1, the operator can make correction inputs via the operator interface 140 if the harvested material does not land at the desired impact location 134 and these are taken into consideration and stored by the model 132 in a self-learning manner. It would also be conceivable to derive the current impact point 134 directly from the image signal of the sensor arrangement 126 or to merge this with the impact point 134 calculated on the basis of the model 132, such as depending on the respective quality of the signals.

The desired impact location and the current impact location are supplied by the module 142 and by the model 132 to a module 150 for generating positioning signals for the actuators 46, 48, 52 and possibly 108, 110. The module 150 calculates the manner in which both impact locations deviate from one another in the forward direction and lateral direction and, based thereon, ascertains the positioning signal in terms of minimizing the deviation between the desired impact location and the current impact location 134, possibly using tables or the like (cf. EP 1 344 445 A1). The module 150 can also be embodied as a multivariable regulator, since the actuators 46, 48, and 52 at least partially influence one another (see EP 1454520 A1). A positioning signal is applied to the actuators 108, 110 if needed, such as if the movement range of the actuators 46, 48, and 52 comes into the vicinity of a stop (cf. EP 1 219 158 A1, EP 2510775 A1, and EP 2827213 A2).

The positioning signal is compared by a module 154 with a signal of the sensor 148 for detecting the current position of the actuator 46, 48, 52 and the difference is supplied to a regulator 152, which is embodied as a PID (proportional-integral-differential) regulator and in turn supervises the hydraulically or electrically operated actuators 46, 48, 52 via suitable valve units or driver circuits. In this case, a variable velocity of the actuators 46, 48, 52 is possible, which is achievable in hydraulic controllers by proportional valves or pulse width-modulated valves in order to be able to variably activate the velocity of the actuators 46, 48, 52 depending on the positioning signal.

The regulator 152 can be viewed with the actuators 46, 48, 52, sensors 148, and the module 154 as an inner control loop, using which the impact point 134 is regulated so that it corresponds to the desired impact point predetermined by the loading strategy 138. The model 132 with the sensors for detecting the current impact point and the modules 142 and 150 form an outer control loop, which specifies the impact point 134 and adjusts it to the inner control loop by way of the positioning signals.

The response sensitivity or aggressiveness of the response of the actuators 46, 48, 52, 108, 110 to a possible deviation between the target position and the actual position of the impact point depends on parameters of the control unit 112, for example the proportionality factor of the regulator 152 of the inner control loop, the maximum magnitude of the positioning signal supplied to the actuators 46, 48, 52 and possibly 108, 110 by the inner control loop and the hysteresis that is used in the outer control loop and defines from which deviation between the target position and the actual position of the impact point 134 a positioning signal will be delivered to the inner control loop. Changing the maximum magnitude of the positioning signal means that the adjustment movement is slower or faster. A proportional valve can be used in this case, for example, for activating a hydraulic cylinder or motor, which valve is opened more or less depending on the magnitude of the positioning signal, or the pulse width, using which a pulse-controlled hydraulic valve is opened, can be varied accordingly. An electric motor can analogously be operated with more or less voltage. The maximum magnitude of the positioning signal accordingly influences the velocity at which the actuator carries out the positioning movement, but not (or indirectly) the temporal duration of the positioning movement.

The greater the response sensitivity or aggressiveness, the faster and greater the response and the accuracy of the regulation, but the greater also the unrest experienced by the operator of the harvesting machine 10 via the actuators 46, 48, 52 and possibly by the operator of the transport vehicle 12 via the actuators 108, 110.

The control unit 112 comprises a module 156 which is used to determine the response sensitivity. The response sensitivity is controlled by the module 156, inter alia, by the operator input unit 140 that can be used by an operator in the cab 26 to input how great the response sensitivity of the control unit should be for a given deviation of the actual position from the target position of the impact point 134. For this purpose, there may be a menu item that can be used by the operator to specify the response sensitivity in two or more stages or continuously, for example between ”aggressive” and ”sluggish”. The response sensitivity specified by the module 156 is supplied to the module 150, which on this basis determines the hysteresis of the outer control loop, and to the regulator 152, which sets the proportionality factor (cf. the preceding paragraph) and/or the maximum adjustment velocity based on it.

Since the response sensitivity expediently depends not only on the operator input via the operator interface 140, but also on other circumstances, a further module 158 is provided for the purpose of detecting parameters affecting the transfer process, which further module in turn provides an output signal to the module 156 which changes the response sensitivity based on these parameters, either in two or more stages or continuously. The module 158 thus informs the module 156 whether a high or low response sensitivity is to be set.

The module 158 is set up to take into account the following parameters when determining the response sensitivity:

(a) The model 132 is configured to detect any transfer losses. As soon as the model detects that the impact point 134 is outside the contours of the cargo container 18, corresponding advice is given to the module 158. Thus, the response sensitivity will be relatively low if there are no transfer losses and is otherwise selected to be as high as possible. If the impact point 134 approaches the contours of the cargo container 18, the response sensitivity can be increased in stages or continuously.

(b) Furthermore, a module 160 is provided for the purpose of detecting a possible relative movement between the cargo container 18 and the harvesting machine 10. The regulation can thus take place more aggressively with greater relative movement, for example when traveling around curves, by adapting the above-mentioned parameters of the inner control loop than in noncritical situations with no or less relative movement. Harvested material losses are thus avoided in the critical situations, without accepting an unnecessarily hectic regulating behavior in noncritical situations.

(c) Furthermore, the module 158 is supplied with information regarding properties of the harvested material, specifically for example the type of harvested material, its moisture and/or its chop length and/or the material throughput and/or the velocity of the transferred material. The response to a given deviation between the desired impact location and the current impact location therefore depends on the harvested material properties mentioned. In this regard, reference is made to the disclosure of DE 102023100539 A1, which is included by reference in the present documents.

During transfer operation, the module 156 sets the response sensitivity for the module 150 (the hysteresis) and the regulator 152 (proportionality factor and/or maximum manipulated variable) depending on the input via the operator interface 140 and the signal from the module 158. For example, how these input variables specify the response sensitivity in detail can be done in such a way that the operator input and the harvested material parameters specify the response sensitivity in the normal case (e.g., without relative movement and without transfer losses), e.g., a response sensitivity specified using the harvested material parameters is overridden by the operator input to a certain extent. In the case of proven transfer losses, the response sensitivity is increased to a maximum, regardless of the operator input and the harvested material parameters. In the case of a proven relative movement, an intermediate value between the maximum response sensitivity and the value normally present can be used. The response sensitivity transmitted to the module 150 and the regulator 152 can be set in two or more stages or continuously.

It can be seen that the response sensitivity is increased whenever it makes sense, such as when transfer losses occur or threaten. In normal operating conditions, the response sensitivity is lower by contrast, which improves operator comfort and reduces the wear on the transfer unit.

What is claimed is:

1. An arrangement for automatically supervising a transfer process, in which harvested material is transferred from a harvesting machine into a cargo container of a transport vehicle, the arrangement comprising:
an electronic control unit configured to:
generate, on the basis of received signals, a positioning signal for one or more actuators configured to alter a location of an impact point of the harvested material in the cargo container; and
transfer, in response to the one or more actuators based on the positioning signal, the harvested material to a target position in the cargo container with a predeterminable response sensitivity to a first deviation between the target position and an actual position of the impact point,
wherein the electronic control unit is configured to increase the response sensitivity when transfer losses are detected.

2. The arrangement of claim 1, wherein the one or more actuators is configured to influence one or more of:
a parameter related to a relative position between the harvesting machine and the cargo container in the forward direction;
a parameter related to a lateral direction of a discharge unit of the harvesting machine;
a parameter related to an angle of the discharge unit of the harvesting machine about a vertical axis;
a parameter related to an angle of a discharge unit of the harvesting machine about a horizontal axis; and
a parameter related to an angle of an end-side discharge flap of the discharge unit of the harvesting machine in relation to the discharge unit.

3. The arrangement of claim 1, wherein the control unit includes an inner control loop configured to activate an actuator of the one or more actuators that is configured to generate at least a part of the positioning signal delivered to the one or more actuators, wherein the inner control loop is configured to activate the actuator of the one or more actuators proportionally in response to the first deviation between the target position and the actual position of the impact point, and
wherein the control unit is configured to specify at least one of a proportional factor and a maximum positioning signal of the inner control loop to specify a response sensitivity.

4. The arrangement of claim 3, wherein the control unit includes an outer control loop configured to ascertain a second deviation between an impact point of the harvested material predetermined by a loading strategy and an impact point of the harvested material ascertained on the basis of the received signals and generate an output signal representative of the second deviation for use together with a sensorially detected value for the current position of the one or more actuators as the input signal for the inner control loop, and wherein a hysteresis of the outer control loop depends on the response sensitivity.

5. The arrangement of claim 4, wherein the control unit is configured to determine the impact point on the basis of sensorially detected values and a model, using the values, for the flight behavior of the harvested material.

6. The arrangement of claim 1, wherein the control unit is configured to take into consideration an operator input for specifying at least one of the response sensitivity, a parameter of the harvested material, and a relative movement between the harvesting machine and the transport vehicle when defining the response sensitivity.

7. A harvesting machine comprising the arrangement of claim 1.
